(19) United States
(12) Patent Application Publication
(10) Pub. No.: US 2006/0157657 A1
(43) Pub. Date: Jul. 20, 2006

(54) Led array circuit

(75) Inventors: Young June Jeong, Suwon (KR); Hun Joo Hahm, Sungnam (KR); Hyung Suk Kim, Suwon (KR); Jung Kyu Park, Seoul (KR); Young Sam Park, Seoul (KR); Ho Sik Ahn, Suwon (KR); Bum Jin Kim, Boochun (KR)

Correspondence Address: MCDERMOTT WILL & EMERY LLP, 600 13TH STREET, N.W., WASHINGTON, DC, 20005-3096, US

(73) Assignee: SAMSUNG ELECTRO-MECHANICS CO., LTD.

(21) Appl. No.: 11/304,821

(22) Filed: Dec. 16, 2005

(30) Foreign Application Priority Data
Jan. 19, 2005 (KR) 10-2005-0005139

(51) Int. Cl. G02B 27/00

(52) U.S. Cl. 250/551

(57) ABSTRACT

Provided is an LED array circuit that has reduced power consumption and can protect an LED from a reverse voltage. The LED array circuit includes an LED pair, and an AC power source for supplying an AC voltage to the LED pair. The LED pair includes a first LED and a second LED that are connected in parallel to each other with biasing polarity connected in reverse.

### RELATED APPLICATION

The present application is based on, and claims priority from, Korean Application Number 2005-5139, filed Jan. 19, 2005, the disclosure of which is hereby incorporated by reference herein in its entirety.

### BACKGROUND OF THE INVENTION

1. Field of the Invention

The present invention relates to a light emitting diode (LED) array circuit, and more particularly, to an LED array circuit that can be used as a backlight source of a liquid crystal display (LCD).

2. Description of the Related Art

An alternative use of an LED instead of a fluorescent lamp as a backlight source of an LCD is recently drawing attention. Compared with a cold cathode fluorescent lamp (CCFL), an LED has a fast response time and an excellent color reproduction characteristic. Moreover, unlike the CCFL, the LED does not require a separate inverter. Therefore, when a plurality of LEDs are used as a backlight source of an LCD, an external circuit can be simplified and a fast response time can be realized.

A plurality of LEDs are required for obtaining the brightness of the CCFL. In this case, since the LEDs operate simultaneously, much power is required. Particularly, a forward current flows through the LEDs serially connected to a DC power source. In this case, the LEDs connected to the DC power source consume a very large amount of power.

FIG. 1 is a schematic circuit diagram of a conventional LED array circuit used as an LCD backlight source.

Referring to FIG. 1, the conventional LED array circuit uses a DC power source 10. Also, the LED array circuit has a plurality of LEDs 11 and 12 serially connected to each other. Specifically, since each of the LEDs 11 and 12 is a kind of a diode that allows a current to flow in one direction only, they are connected in the same electrical direction to allow a current to flow in a forward direction when a DC voltage is applied thereto.

When the DC power source 10 is connected to the LED array circuit to apply a total DC voltage Vₜₒₜₐₗ thereto, power P′ consumed by the LED array can be expressed as Equation 1 below on the assumption that the LED array circuit has no resistance other than that of the LED array and the same voltage V is applied to each of the LEDs.
P′=I×Vₜₒₜₐₗ=I×(V₁+V₂)=2×I×V (1)
where I is a current flowing through the LEDs 11 and 12, and V₁, and V₂ are voltages applied to the LED 11 and the LED 12, respectively. Here, V₁=V₂=V. A larger number of LEDs must be serially connected in a conventional LED array circuit for the LCD backlight source so as to obtain a higher brightness. Therefore, power consumption increases. Also, the LEDs 11 and 12 are connected in the same electrical direction to allow a current to flow in a forward direction. Therefore, when a high reverse voltage (e.g., a reverse electrostatic discharge (ESD) voltage) is suddenly applied to the LED array, the LEDs 11 and 12 may be damaged. Particularly, a GaN-based LED, which has recently gained attention because of its blue light, is weak against damage due to a reverse ESD voltage that may be generated due to its contact with a human body.

U.S. Pat. No. 6,593,597 discloses a technology for protecting an LED from a reverse ESD by connecting the LED in parallel to a Schottky diode. However, according to the above U.S. patent, the Schottky diode must be separately formed, complicating the manufacturing process. Also, the above patent never discloses a method of reducing power consumption generated when the LED array is used as the LCD backlight source.

### SUMMARY OF THE INVENTION

Accordingly, the present invention is directed to an LED array circuit that substantially obviates one or more problems due to limitations and disadvantages of the related art.

An object of the present invention is to provide an LED array circuit having reduced power consumption.

Another object of the present invention is to provide an LED array circuit capable of preventing damage of an LED due to a sudden reverse voltage.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided an LED array circuit including: an LED pair including a first LED and a second LED connected in parallel to each other with biasing polarity connected in reverse; and an AC power source for supplying an AC voltage to the LED pair. The first and second LEDs alternately operate according to the applied AC voltage. Since the LED pair includes the first and second LEDs connected in parallel to each other with biasing polarity connected in reverse, power consumption during the operation of LED array circuit can be reduced when compared to that of the conventional LED array circuit.

The LED pair may be provided in plurality, the plurality of LED pairs being connected in series. In this case, the LED array circuit having higher brightness can be realized.

According to another aspect of the present invention, there is provided an LED array circuit including: a first LED and a second LED each having a p-side electrode and a n-side electrode, the p-side electrode of the first LED being connected to the n-side electrode of the second LED, the n-side electrode of the first LED being connected to the p-side electrode of the second LED; and an AC power source for supplying an AC voltage to the first LED and the second LED.

One terminal of the AC power source may be connected to the p-side electrode of the first LED and the n-side electrode of the second LED, and the other terminal of the AC power source may be connected to the n-side electrode of the first LED and the p-side electrode of the second LED.

The present invention provides an LED array circuit that uses an AC power source. The LED array circuit includes at least one LED pair, and the LED pair includes the first LED and the second LED connected in parallel to each other in with biasing polarity connected in reverse. According to the present invention, not only can power consumption by the LED array be reduced, but the LED can also be effectively protected from a sudden reverse voltage (e.g., a reverse ESD).

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a schematic circuit diagram of a conventional LED array circuit used as an LCD backlight source;

FIGS. 2a and 2b are schematic circuit diagrams of an LED array circuit according to an embodiment of the present invention;

FIG. 3 is a schematic circuit diagram of an LED array circuit according to another embodiment of the present invention; and

FIG. 4 is a schematic sectional view of two LEDs connected in parallel according to an embodiment of the present invention.

### DETAILED DESCRIPTION OF THE INVENTION

Reference will now be made in detail to the preferred embodiments of the present invention, examples of which are illustrated in the accompanying drawings. The invention may, however, be embodied in many different forms and should not be construed as being limited to the embodiments set forth herein; rather, these embodiments are provided so that this disclosure will be thorough and complete, and will fully convey the concept of the invention to those skilled in the art. In the drawings, the shape and the size of an element can be exaggerated for clarity. Like reference numerals in the drawings denote like elements, and thus their description will be omitted.

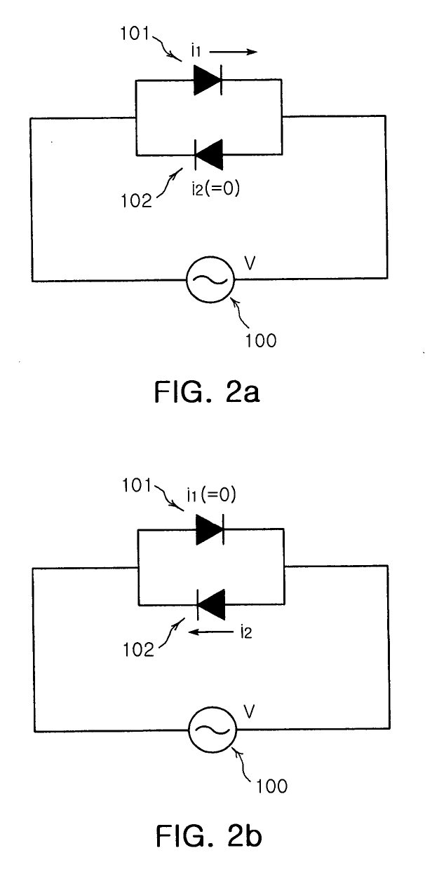

FIGS. 2a and 2b are schematic circuit diagrams of an LED array circuit according to an embodiment of the present invention. FIGS. 2a and 2b illustrate the same LED array circuit, FIG. 2a illustrating a case where a forward current flows through a first LED 101, FIG. 2b illustrating a case where a forward current flows through a second LED 102.

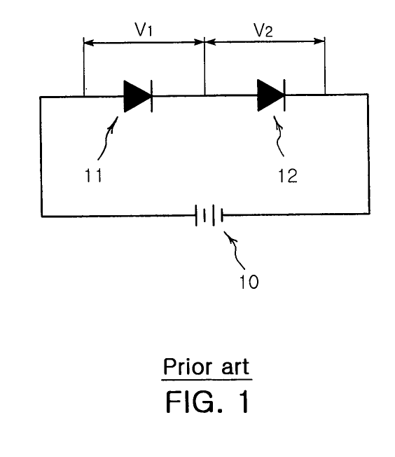

Referring to FIGS. 2a and 2b, the LED array circuit includes an LED pair having the first LED 101 and the second LED 102 connected in parallel to each other with biasing polarity connected in reverse. More specifically, a n-side electrode of the first LED 101 is connected to a p-side electrode of the second LED 102, and a n-side electrode of the second LED 102 is connected to a p-side electrode of the first LED 101. The LED array circuit uses a AC power source 100 instead of the DC power source 10 illustrated in FIG. 1. The terminals of the AC power source 100 are connected to the LED pair to supply an AC voltage thereto.

A connection structure of the first and second LEDs 101 and 102 will be described in detail with reference to FIG. 4.

Referring to FIG. 4, the first LED 101 includes a substrate 51, an n-type clad layer 52, an active layer 53, a p-type clad layer 54, a transparent electrode 55, a p-side electrode 57, and a n-side electrode 56. Likewise, the second LED 102 includes a substrate 61, an n-type clad layer 62, an active layer 63, a p-type clad layer 64, a transparent electrode 65, a p-side electrode 67, and a n-side electrode 66. The first and second LEDs 101 and 102 are connected in parallel to each other with biasing polarity connected in reverse. That is, the p-side electrode 57 of the first LED 101 is connected to the n-side electrode 66 of the second LED 102, and the n-side electrode 56 of the first LED 101 is connected to the p-side electrode 67 of the second LED 102. Also, one terminal of the AC power source 100 is connected to the p-side electrode 57 of the first LED 101 and the n-side electrode 66 of the second LED 102, and the other terminal of the AC power source 100 is connected to the n-side electrode 56 of the first LED 101 and the p-side electrode 67 of the second LED 102.

An operation of the LED array circuit will be described in detail with reference to FIGS. 2a and 2b.

Referring to FIG. 2a, when a forward voltage is applied from the AC power source 100 to the first LED 101, a current i₁ flows through the first LED 101 and thus the first LED 101 emits light. At this point, since a reverse voltage is applied to the second LED 102, a current does not flow substantially through the second LED 102 (i₂=0) Referring to FIG. 2b, when a forward voltage is applied from the AC power source 100, which rapidly changes it voltage polarity, to the first LED 101, a current i₂ flows through the second LED 102 and thus the second LED 102 emits light. At this point, since a reverse voltage is applied to the first LED 101, a current does not flow substantially through the first LED 101 (i₁=0). In this manner, the LEDs 101 and 102 alternately operate according to the polarity of the voltage from the AC power source 100. At this point, power consumption P can be expressed as Equation 2 below on the assumption that the forward currents i₁ and i₂ are the same and the voltages applied to the LEDs 101 and 102 are ‘v’.
P=v×i₁=v×i₂v×i (where i₁=i₂=i) (2)

Since root mean square (RMS) values iᵣₘₛ and vᵣₘₛ, not peak values iₚₑₐₖ and vₚₑₐₖ, is used as an effective value of an alternating current and voltage, the power consumption P can be expressed as Equation 3 below.
P=v×i=vᵣₘₛ×iᵣₘₛ=½vₚₑₐₖ×iₚₑₐₖ (3)

The power consumption P of the LED array circuit in FIG. 2 will now be compared with the power consumption P′ of the conventional LED array circuit in FIG. 1. For the comparison, it is assumed that the voltages (peak voltages) applied to the respective LEDs are the same and the currents (peak currents) flowing through the respective LEDs are the same. Under the above assumption, V₁=V₂=vₚₑₐₖ=V, and I=iₚₑₐₖ. Equations 4 and 5 below are derived from Equations 3 and 1. Here, V₁, and V₂ are voltages applied to the LED 11 and the LED 12, respectively, and I is a current flowing through the LEDs 11 and 12.
P=½×V×I (4)
P′=2×V×I (5)

As can be seen from Equations 4 and 5, the power consumption P of the LED array circuit in FIG. 2 is one-fourth of the power consumption P′ of the conventional LED array circuit in FIG. 1. That is, the power consumption of the LED array circuit in FIG. 2 can be remarkably reduced.

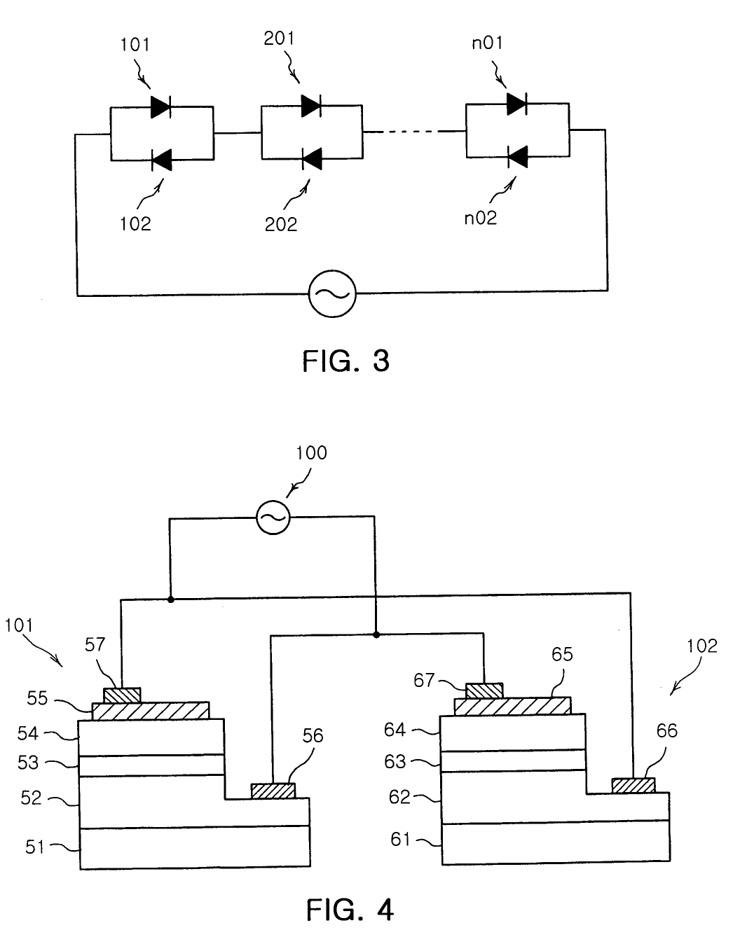

FIG. 3 is a schematic circuit diagram of an LED array circuit according to another embodiment of the present invention.

Referring to FIG. 3, the LED pair illustrated in FIGS. 2a and 2b (refer to the reference numerals 101 and 102) is provided in plurality. A plurality of LED pairs including first LEDs (101, 201, . . . , n01) and second LEDs (102, 202, . . . , n02) are connected in series. Since the LED array circuit includes an n number of LED pairs connected in series, it can provide n times the brightness of the LED array circuit in FIG. 2.

According to the LED array circuits illustrated in FIGS. 2a, 2b, and 3, not only can power consumption be reduced in comparison with the conventional LED array circuit, but also the LED can be protected from a high reverse voltage (e.g., a reverse ESD voltage) that is suddenly generated. In the conventional LED array circuit, since all of the LEDs are arranged in the same direction, the LED may be damaged when a sudden reverse voltage is applied thereto. On the contrary, when the first LED 101 and the second LED 102 are connected in parallel to each other with biasing polarity connected in reverse as in the present embodiment, an ESD voltage can be easily discharged through the LED to which a forward voltage is applied, regardless of the direction of the applied ESD voltage. Therefore, the damage of the LED by the ESD voltage can be effectively prevented, and thus the lifetime of the LED array circuit can be greatly extended.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. An LED array circuit comprising:
an LED pair including a first LED and a second LED connected in parallel to each other with biasing polarity connected in reverse; and
an AC power source for supplying an AC voltage to the LED pair.

2. The LED array circuit of claim 1, wherein the first and second LEDs alternately operate according to the applied AC voltage.

3. The LED array circuit of claim 1, wherein the LED pair is provided in plurality, the plurality of LED pairs being connected in series.

4. An LED array circuit comprising:
a first LED and a second LED each having a p-side electrode and a n-side electrode, the p-side electrode of the first LED being connected to the n-side electrode of the second LED, the n-side electrode of the first LED being connected to the p-side electrode of the second LED; and
an AC power source for supplying an AC voltage to the first LED and the second LED.

5. The LED array circuit of claim 4, wherein one terminal of the AC power source is connected to the p-side electrode of the first LED and the n-side electrode of the second LED, and the other terminal of the AC power source is connected to the n-side electrode of the first LED and the p-side electrode of the second LED.
